(19) United States
(12) Patent Application Publication
(10) Pub. No.: US 2014/0049547 A1
(43) Pub. Date: Feb. 20, 2014

(54) Methods and Systems for Representing Complex Animation using Style Capabilities of Rendering Applications

(71) Applicants: Rick Cabanier, Seattle, WA (US); Dan J. Clark, Big Sur, CA (US); David George, Redwood City, CA (US)

(72) Inventors: Rick Cabanier, Seattle, WA (US); Dan J. Clark, Big Sur, CA (US); David George, Redwood City, CA (US)

(73) Assignee: Adobe Systems Incorporated, San Jose, CA (US)

(21) Appl. No.: 13/018,830

(22) Filed: Feb. 1, 2011

(51) Int. Cl. G06T 13/00

(52) U.S. Cl. 345/473

(57) ABSTRACT

A computerized device implements an animation coding engine to analyze timeline data defining an animation sequence and generate a code package representing the animation sequence as a set of visual assets and animation primitives supported by a rendering application, each visual asset associated with a corresponding animation primitive. The code package is generated to include suitable code that, when processed by the rendering application, causes the rendering application to invoke the corresponding animation primitive for each visual asset to provide the animation sequence. For example, the rendering application can comprise a browser that renders the visual assets. The code package can comprise a markup document including or referencing a cascading style sheet defining the corresponding animation primitives as styles to be applied to the visual assets when rendered by the browser.

### BACKGROUND

Animation is a popular way to provide content, whether for artistic, commercial, or other purposes. Runtime applications, such as those executed using the Adobe® Flash® player (available from Adobe Systems Incorporated of San Jose, Calif.), are an effective option for distributing animated content via the Internet. For instance, a runtime application can comprise code that, when executed in a corresponding runtime environment, presents a desired animation sequence, such as a one or more animated objects that move and/or otherwise change in a time-varying manner on a stage in an interface rendered by the runtime application. However, runtime-based animation may not always be available—for example, certain devices or platforms may not support use of a runtime environment. Developers may nonetheless wish to provide animated content for such platforms, such as animated content for use with rendering applications (e.g., browsers) that can provide animation but cannot work with the runtime environment.

### SUMMARY

A computerized device includes a hardware interconnect and a data processing hardware element (e.g., a processor and/or hardware logic) interfaced to the hardware interconnect. The data processing hardware element implements an animation coding engine to analyze timeline data defining an animation sequence and generate a code package representing the animation sequence as a set of visual assets and animation primitives supported by a rendering application, each visual asset associated with a corresponding animation primitive. The generated code package is stored via the hardware interconnect in local or remote storage. The code package is generated to include suitable code that, when processed by the rendering application, causes the rendering application (e.g., browser) to invoke the corresponding animation primitive for each visual asset to provide the animation sequence.

These illustrative embodiments are discussed not to limit the present subject matter, but to provide a brief introduction. Additional embodiments include computer-readable media embodying an application configured in accordance with aspects of the present subject matter to provide an animation coding engine. Embodiments also include computer-implemented methods for generating code packages that can be processed by a rendering application to provide animation based on invoking animation primitives native to the rendering application. These and other embodiments are described below in the Detailed Description. Objects and advantages of the present subject matter can be determined upon review of the specification and/or practice of an embodiment configured in accordance with one or more aspects taught herein.

### BRIEF DESCRIPTION OF THE DRAWINGS

A full and enabling disclosure is set forth more particularly in the remainder of the specification. The specification makes reference to the following appended figures.

FIG. 1 is a diagram of an illustrative animation sequence.

FIG. 2 is a diagram showing an illustrative computing device implementing an animation coding engine.

FIG. 3 is a data flow diagram showing the code generation process.

FIG. 4 is a flowchart showing an illustrative method for generating a code package based on timeline data.

FIG. 5 is a flowchart showing an example of a heuristic for recognizing design patterns while analyzing timeline data.

FIG. 6 is a block diagram showing an illustrative architecture for a development environment that utilizes an animation coding engine configured according to the present subject matter

### DETAILED DESCRIPTION

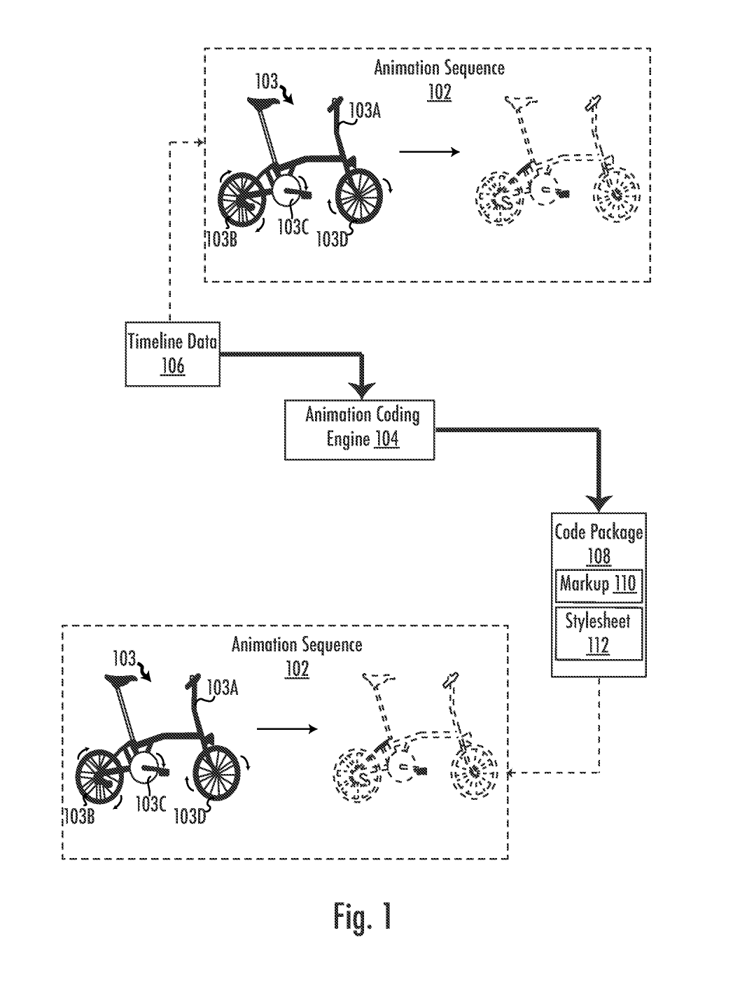

Presently-disclosed embodiments include computing systems, methods, and computer-readable media embodying code. Turning to FIG. 1, for example, an illustrative animation sequence 102 is shown in which a bicycle 103 moves across a stage from left to right. The bicycle's wheel 103B, crank 103C, and wheel 103D may be represented as vector or raster graphics, for example, that rotate as the body 103A of the bicycle moves across the screen. In accordance with presently-disclosed embodiments, an animation coding engine 104 can be used to analyze timeline data 106 defining the components and movement (i.e., the animation) of bicycle 103 into a code package 108. Code package 108 comprises code that, when processed by a rendering application (e.g., a browser), causes the rendering application to reproduce the animation sequence as again shown at the bottom of FIG. 1.

The term “code package” is used to indicate that although the animation sequence is the same, the output of the animation engine is not independently executable. Rather, the animation engine provides a code package comprising one or more files that invoke native animation capabilities of rendering application when the rendering application interprets or otherwise acts based on the contents of the code package.

For example, the code package may comprise markup code 110 referencing visual assets of the animation sequence and a stylesheet 112 that defines animation primitives as styles applied to visual assets. When a rendering application renders the visual assets, animation capabilities of rendering application are invoked according to the styles applied to the respective visual assets. As a particular example, the stylesheet may be a Cascading Style Sheet (CSS) 112 formatted according to CSS3 standards, with the stylesheet referenced by or included in an HTML file specifying element such as bicycle 103's body 103A, rear wheel 103B, crank 103C, and front wheel 103D as separate image files.

Animation coding engine 104 is capable of decomposing complex animation sequences into an arrangement of animation primitives supported by the browser to thereby take advantage of the browser's native rendering capabilities without the need for the browser to itself support highly complex animation commands. Instead, the timing and arrangement of animation primitives is orchestrated by code package 108. Additionally, the structure of the HTML file can be used to drive the animation according to parameters specified in the style sheet. Because the HTML elements are handled directly by the rendering application's HTML parser, the resulting animated elements are handed in a stand-alone manner, which makes for smoother animations and easier editing as compared to other approaches, such as including animation metadata interpreted by JavaScript or other intermediate approaches.

For example, bicycle 103 can be represented using separate image files for each of components 103A, 103B, 103C, and 103D. Appropriate CSS3 animation parameters can be defined as a style applied to element 103A to translate body 103A from left to right. Styles applied to elements 103B and 103D can be used to rotate the wheels of the bicycle and translate the wheels in conjunction with body 103A. An additional style can be used to provide independent rotation of crank 103C while also translating crank 103C across the stage.

Reference will now be made in detail to various and alternative exemplary embodiments and to the accompanying drawings. Each example is provided by way of explanation, and not as a limitation. It will be apparent to those skilled in the art that modifications and variations can be made. For instance, features illustrated or described as part of one embodiment may be used on another embodiment to yield a still further embodiment.

In the following detailed description, numerous specific details are set forth to provide a thorough understanding of the subject matter. However, it will be understood by those skilled in the art that the subject matter may be practiced without these specific details. In other instances, methods, apparatuses or systems that would be known by one of ordinary skill have not been described in detail so as not to obscure the subject matter.

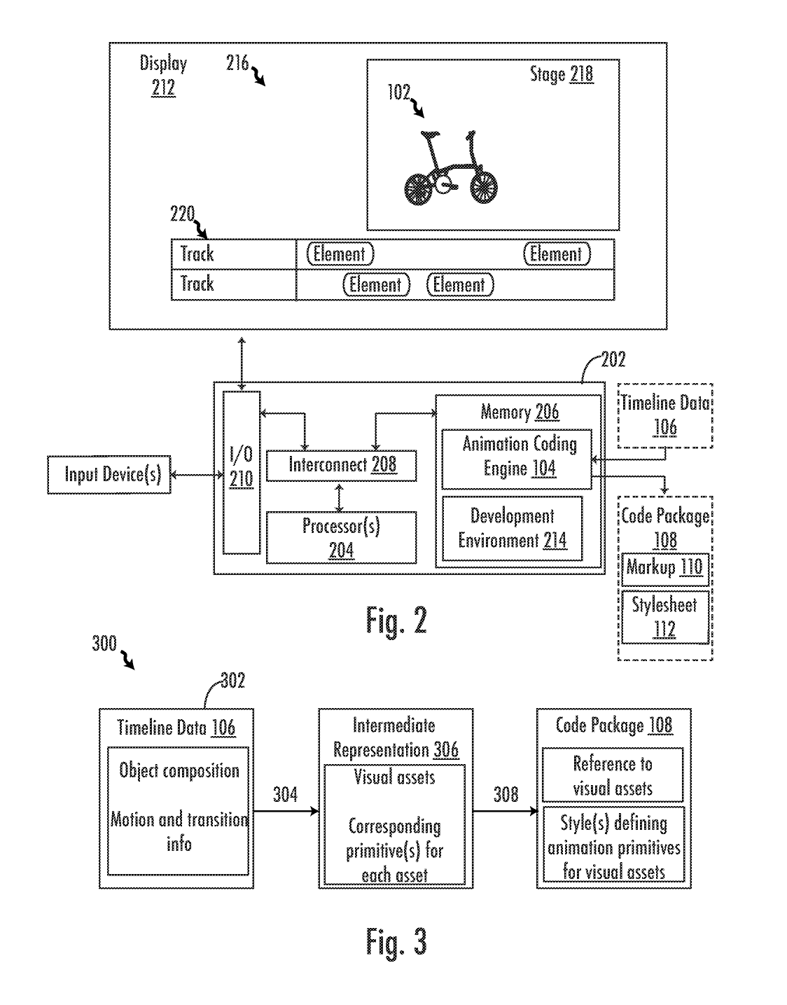

FIG. 2 is a diagram showing an illustrative computing device 202 being used to convert animation sequence 102 into a code package 108. Computing device 202 may alternately be referred to as a data processing system, computerized device, or simply a “computer.” Computing device 202 represents a desktop, laptop, tablet, or any other computing system. Other examples of computing device 202 include, but are not limited to, servers, mobile devices (PDAs, smartphones, media players, gaming systems, etc.) and embedded systems (e.g., in vehicles, appliances, or other devices).

Generally speaking, computing device 202 features one or more data processing hardware elements implementing an animation coding engine 104. Animation coding engine 104 causes computing device 202 to analyze timeline data 106 defining animation sequence 102 and generate code package 108 representing the animation sequence 102. In this example, animation sequence 102 is movement of bicycle 103 across the stage, but in practice animation sequences may be much more complex. As noted above, the code package is generated so that, when the code is processed by rendering application, native animation capabilities of rendering application 102 are invoked to provide the animation sequence by using the corresponding animation primitive for each visual asset 114.

Animation coding engine 104 can be implemented in hardware accessible by or as part of the data processing element (e.g., as an application-specific integrated circuit, (ASIC), programmable logic device (e.g., PLAs, FPGAs, etc.)). As another example, animation coding engine 104 can be implemented using software or firmware that configures the operation of a processor or processors.

In the example shown in FIG. 2, computing device 202 features a data processing hardware element comprising one or more processors 204 and a computer-readable medium (memory 206) interconnected via an interconnect 208, representing internal busses, connections, and the like. Interconnect 208 also connects to I/O components 210, such as universal serial bus (USB), VGA, HDMI, serial, and other I/O connections to other hardware of the computing system. The hardware also includes one or more displays 212. It will be understood that computing device 202 could include other components, such as storage devices, communications devices (e.g., Ethernet, radio components), and other I/O components such as speakers, a microphone, or the like. Generally speaking, interconnect 208 is used to store the generated code package, such as in a local hard drive, network storage, and/or to relay the generated code via a network connection to a destination. Input is provided via suitable input devices such as a mouse, keyboard, touch screen interface, etc.

Computer-readable medium 206 may comprise RAM, ROM, or other memory and in this example embodies a development environment 214 and the animation coding engine 104. More generally, development environment 214 is provided as an example of one or more applications or processes utilizing or including animation coding engine 104. For example, development environment 214 may comprise a development application such as Adobe® Flash® Professional, available from Adobe Systems Incorporated, and suitably modified to include or utilize animation coding engine 104.

As shown here, development environment 214 provides a user interface 216 that includes a stage 218 and a timeline 220. Stage 218 can be used to arrange one or more objects that are to be animated, with timeline 220 providing a visual representation of timeline data 106 and usable to select time intervals. For example, timeline 220 may be used to select different frames or other time index units, with animated objects positioned at different locations at the different frames. In some implementations, development environment 214 may support tweening and other operations so that a user does not need to specify every intermediate position of an object—instead, the user may specify starting and ending locations in respective key frames and/or a desired path, with development environment 214 handling the details of correctly positioning the object(s) in between the key frames. For example, a user may specify a starting and ending location for bicycle 103 and development environment 214 handles the details of smoothly translating the bicycle across the stage. Although this example shows a stage and timeline, a development environment may support other methods for receiving input specifying an animation sequence. For example, a source code view may be provided, with the animation specified through suitable syntax for specifying the location and motion of objects.

In this example, animation coding engine 104 is shown as part of a client-side development environment. However, animation coding engine 104 could be deployed at a remote server. For example, a web service may host animation coding engine 104 and provide a client-side front end for providing a user interface whereby a user can define the animation sequence. As another example, animation coding engine 104 could be deployed as part of a web service that receives timeline data 106 from a client and returns code package 108 in response.

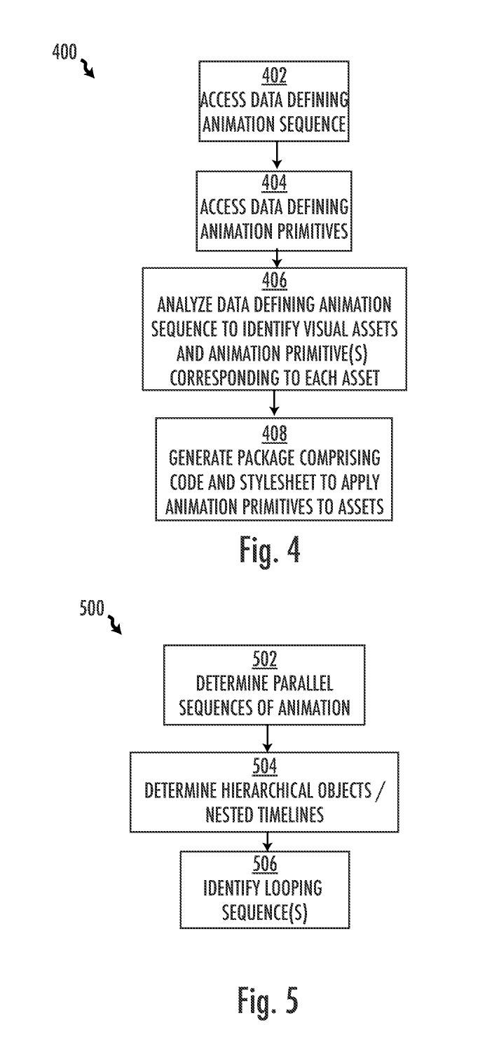

In any event, animation coding engine 104 is provided with access to timeline data 106 specifying the details of animation sequence 102 and uses that data to generate code that is processed by a rendering application to replicate the animation sequence. FIG. 3 is a data flow diagram 300 generally showing the code generation process, carried out by animation coding engine 104 executed by computing system 202, while FIG. 4 is a flowchart discussing an illustrative code generation method 400.

As shown at 302, animation coding engine 104 begins from the timeline data 106 defining the animation sequence of one or more animated objects. For example, timeline data 106 may comprise source code and/or an object model of a runtime application, such as source code of a Flash® application. However, it will be understood that timeline data 106 can comprise another representation of an animation sequence.

As shown at 304, this data is analyzed to determine visual assets comprising the animated object(s) along with data identifying motion and/or other time-varying properties of the visual assets as the animation sequence occurs. An object as represented in timeline data 106 may, practically speaking, be animated using one visual asset or multiple visual assets manipulated in concert with one another. For example, as noted above, bicycle 103 of FIG. 1 may be defined using vector or raster graphics that specify a desired appearance of body 103A, wheels 103B and 103D, crank 103C, and other portions thereof. Additionally, timeline data 106 may define interrelationships among the assets, such as joints between body 103A and its wheels. Motion of bicycle 103 may be defined in terms of rotation of its wheels and starting and ending coordinates for the whole bicycle, for example.

By analyzing how the underlying visual assets move or otherwise vary over time, animation coding engine 104 provides a representation of the animation as a set of visual assets and corresponding animation primitives as shown at 306. As discussed below, animation coding engine 104 may analyze the animation sequence using a heuristic that searches for common design patterns that can be broken down into sets of animation primitives.

As shown at 308, code package 108 can be generated by selecting appropriate code statements for the rendering application that is to process code package 108. For example, in some implementations code package 108 is provided as an HTML file along with a CSS3-compliant style sheet. The HTML file can reference the visual assets along with statements to invoke styles defined in the style sheet. The style sheet can be populated with style definitions for the corresponding animation primitives. When a rendering application such as a browser processes code package 108, the rendering application's native animation capabilities can be invoked based on the style definitions.

FIG. 4 is a flowchart showing an illustrative method 400 for generating a code package 108 which may be carried out by animation coding engine 104 of FIGS. 1-2 according to the data flow of FIG. 2.

Block 402 represents accessing data defining an animation sequence, the animation sequence depicting motion of at least one object over time. For instance, the animation sequence may be defined in terms of a location on a stage for each of one or more objects and corresponding time index values. As a particular example, a development environment may maintain a core object model and codebase for the application under development. The object model/codebase can include data representing the various application components, including the object(s) to be animated (e.g., bicycle 103 of FIG. 1 and its constituent elements) along with scripting components and other data defining the desired time-varying activity of the object(s) the be animated, including motion, transition effects, and the like (e.g., starting and ending locations of bicycle 103, a number of frames during which the translation occurs, rate of rotation of its wheels, etc.).

Block 404 represents accessing data identifying animation primitives supported by a markup language. For instance, animation coding engine 104 may be hard-coded to recognize some or all of a set of animation operations that can be invoked through use of a style sheet, such as a CSS3 stylesheet. As another example, animation coding engine 104 may selectively access different sets of primitives supported by different style sheet languages, different rendering applications, and the like based on a desired output format.

Block 406 represents analyzing the data defining the animation sequence to determine a set of visual assets and corresponding animation primitives representing the motion of the at least one object over time. For example, animation coding engine 104 may use the data describing object positions over time and/or data defining time-varying activity of the objects to identify one or more sequences of motion that can be matched to animation primitives. The animated object(s) can be broken down into one or more visual assets, with each visual asset animated individually in a way so that the original timing of the animation sequence is maintained along with the intended relative position of the animated object(s). For example, bicycle 103 can be broken into body 103A, wheel 103B, crank 103C, and wheel 103D.

As an example, the animated object(s) may be analyzed to determine a first position of a visual asset on the stage at a first time index and a second position of the visual asset on the stage at a second time index. Based on the first and second positions and the time indices a suitable animation primitive be selected. For example, if the asset translates across the stage, then the animation coding engine can select an animation primitive that, when processed by the rendering application, causes the rendering application to move the visual asset to a second position in the interface of the rendering application corresponding to the second position of the visual asset on the stage. As a particular example, the webkit—transform primitive can be selected for use as a style applied to each element 103A, 103B, 103C, and 103D, with values to define the starting and ending locations and a desired rate for the translation can be determined. For assets such as elements 103B, 103C, and 103D that rotate, a rotation primitive can be selected through a similar analysis. Transitions (e.g., fade-in, fade-out), distortions, and other manipulations can be identified as well.

Block 408 represents generating a package comprising markup code referencing the set of visual assets and a stylesheet defining the corresponding animation primitives as styles to be applied to the visual assets, the package generated so that, when the markup code is processed by a rendering application, the rendering application invokes the corresponding animation primitives to animate the visual assets. For example, a set of files can be provided, the set of files including markup code renderable by a browser and referencing a stylesheet. As noted above, the stylesheet can define the selected animation primitives as styles applied to the corresponding visual assets.

The markup code can specify the visual assets in a way that causes the rendering application to treat each visual asset as a separate element. As a result, each element can be animated in a stand-alone manner. This can enhance the resulting animation by allowing the markup code to drive the animation as set forth in the styles.

The styles can be defined using parameter values that preserve the relative timing of the animations of various assets and spatial relationship of the assets over the course of the animation. For example, certain animations may be delayed relative to others and/or repeated, with duration values for the animation primitives used to control relative speed between animations. Coordinate values can be included in the style definitions so that the arrangement of the visual assets remains true to the original animation sequence as assets are translated, rotated, distorted, and the like. The visual assets may themselves be included as files (e.g., raster image files, scalable vector graphics files) or may be defined as elements in the markup code.

For example, animation sequence 102 of FIG. 1 can be represented as an HTML file. To cause the rendering application to treat the visual assets of bicycle 103 separately, the HTML file an have four uniquely named <DIV> elements, one <DIV> element for each of body 103A, wheel 103B, crank 103C, and wheel 103D and referencing an appropriate image asset for the respective component (e.g., an SVG file for body 103A, wheel 103B, crank 103C, and wheel 103D). A corresponding style can be defined for each <DIV> element. In particular, a translate style can be defined for body 103A. For wheels 103B and 103D, a translate+rotate style can be defined; in practice both wheels could be animated using the same style or unique styles. The <DIV> element referencing crank 103C can also have a translate+rotate style, but with a different rate of rotation specified.

In some implementations, the package further comprises scripting code to be interpreted by the rendering application when the markup code is processed. For example, in some implementations, JavaScript is used to control the start and repetition (if desired) of the animation. For example, a JavaScript file can be included to begin the animation when an HTML document is loaded and to repeat the animation after a specified time period. For example, if crank 103C is rotated at a high rate, its animation may be repeated on an infinite loop while slower rotations for wheels 103B and 103D are used once during the entire animation sequence.

In some implementations, analysis block 406 operates according to a heuristic that decomposes the animation sequence based on common design patterns that can be used in selecting and arranging animation primitives. FIG. 5 is a flowchart showing an example of a heuristic at 500 that searches for three design patterns, though other heuristics could search for more or fewer patterns.

Block 502 represents determining if the animation sequence includes parallel sub-sequences over the course of the animation. This may include multiple objects moving or otherwise varying in different ways during an animation. For example, in a basic case of two objects moving across the stage in parallel, a style can be defined for each object (e.g., webkit-translate). However, the parameters for each style can be set so that the motion of the objects remains true to that defined in timeline data 106.

For example, the animation sequence may define motion of a first object that occurs simultaneous to motion of a second object. The analysis of timeline data 106 can determine appropriate location and timing parameters to use in style definitions for the first and second objects. Non-parallel animations can be handled sequentially. For instance, if one of the objects moves after the other, then the analysis can determine an appropriate delay factor to include in the style definitions so that the proper timing of the animations is maintained.

Block 504 represents determining whether the animation sequence includes a hierarchical object. Development environment 214 may allow a user to define a hierarchical object that itself comprises multiple different objects with animated behavior. For example, a Flash® application may be defined in terms of a main timeline that describes motion of an object over a time interval, with the object itself including additional objects that are animated according to their own nested timelines. As a particular example, motion of an animated creature may be defined in a main timeline and describe how the creature moves across the stage. The creature's eyes may each have their own timeline describing blinking, motion, or other effects. As another example, animation sequence 102 as defined in timeline data 106 may specify bicycle 103 as a hierarchical object including body 103A and wheel 102B, crank 102C, and wheel 102D each defining rotation in a nested timeline. In that case, translation may be defined with respect to the hierarchical object, with the translation of wheel 102B, crank 102C, and wheel 102D implied via the nested timelines.

Thus, at block 504, animation coding engine 104 dives into the nested timelines to determine all of the animated effects are to occur at a given point in time, including animations inherited by nested objects. This can be used in the code generation process—returning to the “creature” example, a style can be defined to move the visual assets corresponding to the creature's body and a style can be defined for the creature's eyes. Due to the nested timeline, the style for the creature's eyes should define a translation corresponding to the translation of the body (assuming no intended eye wobble in the original animation). However, one or more additional styles can be defined for the eye-related effects (e.g., a webkit-transition primitive can be used to bring the creature's eyelids in and out of view for the blink animations).

Block 506 represents identifying a looping sequence in the animation sequence. A looping sequence can be identified based on repeated activity in a timeline, either expressly repeated or implied. As an example of an expressly repeated loop, a timeline may indicate that an object is to begin from a first position, move, and return to the first position a number of times. During the code generation process, this activity can be simplified into a single sequence repeated a number of times. For example, the analysis may determine how many times the sequence repeats and suitable JavaScript can be included in code package 108 to invoke the sequence the determined number of times. As another example, the desired loop count for the animation can be included in the stylesheet defining the animation. If the loop includes a delay (e.g., the object appears, moves, and disappears before reappearing), a delay factor can be included in the object's style definition.

A hierarchical object can imply a looping sequence. For example, as noted above bicycle 103 may be defined in a main timeline with nested timelines for the wheels and cranks. The wheel rotation may be defined as only a few frames which are automatically repeated while the main timeline extends over a much larger number of frames (e.g., as the bicycle object translates across the screen). If in animation sequence 102 bicycle 103 moves, stops, and moves again, then the rotation of wheels 102B/102D and crank 102C may be looped on a delay to correspond to the start and stop of the bicycle. Thus, block 506 can represent determining a number of repetitions of the wheel rotation animation for use over the course of the full animation.

By analyzing complex animations defined in timeline data 106 according to a heuristic, such as that of FIG. 5, complex animations can be readily represented using simpler animation primitives supported by browsers and other rendering applications. This can allow for generation of efficient code that accurately reproduces complex animations while leveraging the advantages of the rendering application's native animation capabilities. For example, the rendering application's animation capabilities may be implemented directly using graphics processing unit (GPU) capabilities of the computing device providing the rendering application, which can result in higher framerates and smoother motion.

By specifying the visual assets directly in markup to be processed by the HTML rendering engine according to CSS or other style-based animation definitions, performance can be enhanced as compared to solutions that use an intermediate layer of processing. In particular, the HTML file drives the animation sequence because the HTML file is what is parsed and rendered. The HTML parser and its event model, which are provided by functional modules compiled/configured in a way to efficiently invoke the hardware capabilities of the device providing the HTML parser, are used to provide the animations in accordance with the style definitions.

Thus, there is not delay due to intermediate processing while actually carrying out the animations, such as delay due to parsing and interpreting JavaScript code to move a <canvas> or other element. Of course, present embodiments can use JavaScript as an event driver (e.g., to start and repeat animation sequences), but such operations are less computationally intensive than using JavaScript to actually provide the animation.

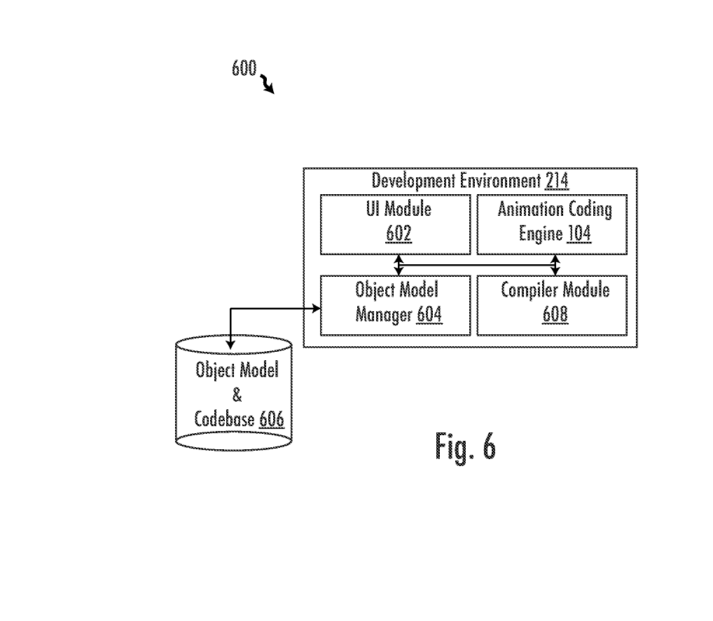

FIG. 6 is a block diagram showing an illustrative architecture 600 for a development environment 214 that utilizes an animation coding engine 104 configured in accordance with the present subject matter. In this example, application development environment 214 also includes a UI module 602 used to provide a graphical user interface and receive user input. For example, UI module can render graphical user interface 216 of FIG. 2, including design stage 218, timeline view 220, and other interfaces (e.g., code view interface, etc.) and populate the interface with animation sequence 102 as the sequence is defined/edited.

Object model manager module 604 can access stored data representing a core object model and codebase 606 for the application under development. The object model/codebase can include data representing the various application components, including media elements, scripting components, and the like and is representative of timeline data 106 used by animation coding module 104. For example, module 604 can store vector, raster, or other graphics representing bicycle 103 along with data defining the location of bicycle 103 in various frames, along with desired motion effects as bicycle 103 changes position in the different frames.

As discussed above, animation coding module 104 can use timeline data 106 to decompose an animation sequence into a plurality of visual assets and select corresponding animation primitives to be applied to those visual assets in order to replicate the animation sequence by way of a code package 108 processed by a rendering application. Module 104 can, for example, carry out analysis according to FIGS. 3-5 discussed above. Development application 212 also includes compiler module 608. Compiler module 608 can use the object model/codebase to produce executable or interpretable code of the application under development. Output code may, for example, comprise SWF files or AIR files for execution using Adobe® Flash® or AIR®, files for execution in another runtime environment, files for execution in an operating system, or the like.

It will be understood that the present subject matter can be used regardless of the format or type of the application under development, and construction and use of appropriate compilers, linkers, and packaging components (e.g., for cross-platform compatibility) will be within the ability of one of skill in the art. This may allow a developer to generate an animation sequence once and then output the sequence in multiple different formats (e.g., in HTML/CSS3 and as a Flash® application).

Animation coding engine 104 is shown integrated into development environment 214 in this example. It will be understood that animation coding engine 104 can operate independently of development environment 214. For example, animation coding engine 104 could be implemented with its own UI module used to select files containing timeline data 106 and convert those files into a code package 108.

### General Considerations

Some portions of the detailed description were presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here and generally is considered to be a self-consistent sequence of operations or similar processing leading to a desired result. In this context, operations or processing involve physical manipulation of physical quantities.

Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels.

Unless specifically stated otherwise, as apparent from the foregoing discussion, it is appreciated that throughout this specification discussions utilizing terms such as “processing,” “computing,” “calculating,” “determining” or the like refer to actions or processes of a computing platform, such as one or more computers and/or a similar electronic computing device or devices, that manipulate or transform data represented as physical electronic or magnetic quantities within memories, registers, or other information storage devices, transmission devices, or display devices of the computing platform.

Although several examples featured mobile devices, the various systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software, that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

A computing device may access one or more non-transitory computer-readable media that embody computer-readable instructions which, when executed by at least one computer, cause the at least one computer to implement one or more embodiments of the present subject matter. When software is utilized, the software may comprise one or more components, processes, and/or applications. Additionally or alternatively to software, the computing device(s) may comprise circuitry that renders the device(s) operative to implement one or more of the methods of the present subject matter.

Examples of computing devices include, but are not limited to, servers, personal computers, mobile devices (e.g., tablets, smartphones, personal digital assistants (PDAs), etc.) televisions, television set-top boxes, portable music players, and consumer electronic devices such as cameras, camcorders, and mobile devices. Computing devices may be integrated into other devices, e.g. “smart” appliances, automobiles, kiosks, and the like.

Embodiments of the methods disclosed herein may be performed in the operation of computing devices. The order of the blocks presented in the examples above can be varied—for example, blocks can be re-ordered, combined, and/or broken into sub-blocks. Certain blocks or processes can be performed in parallel.

Any suitable non-transitory computer-readable medium or media may be used to implement or practice the presently-disclosed subject matter, including, but not limited to, diskettes, drives, magnetic-based storage media, optical storage media (e.g., CD-ROMS, DVD-ROMS, and variants thereof), flash, RAM, ROM, and other memory devices.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

1. A computing device, comprising:
a hardware interconnect; and
a data processing hardware element interfaced to the hardware interconnect,
wherein the data processing hardware element implements an animation coding engine configured to:
analyze timeline data defining an animation sequence for an object comprising a set of visual assets, the timeline data indicating time-varying properties of respective ones of the set of visual assets; and
generate a code package representing the animation sequence as the set of visual assets and animation primitives supported by a rendering application, each visual asset being associated with a corresponding animation primitive and generated markup code stored via the hardware interconnect,
wherein the code package is generated so that, when the code package is processed by the rendering application, the code package causes the rendering application to invoke the corresponding animation primitive and the generated markup code for each visual asset in accordance with the time-varying properties to depict the animation sequence.

2. The computing device of claim 1, wherein:
the rendering application comprises a browser configured to render the visual assets, and
the generated markup code comprises:
a reference to each of the visual assets as a separate element and
a cascading style sheet defining the corresponding animation primitives as styles to be applied to the visual assets referenced by the separate elements when the visual assets are rendered by the browser.

3. The computing device of claim 1, wherein:
analyzing the timeline data comprises decomposing the animation sequence into a plurality of parallel sub-sequences, each sub-sequence representing motion of one of a plurality of different objects, and
generating the code package comprises generating code that, when processed by the rendering application, causes the rendering application to:
render a plurality of visual assets, each visual asset of the plurality of visual assets corresponding to one of the plurality of different objects; and
invoke the corresponding animation primitives for the plurality of visual assets in parallel.

4. The computing device of claim 1, wherein:
analyzing the timeline data comprises identifying motion of a hierarchical object; and
generating markup code comprises determining a plurality of visual assets associated with the hierarchical object, the corresponding animation primitives for the visual assets defining motion being based at least in part on the identified motion of the hierarchical object.

5. The computing device of claim 1, wherein:
analyzing the timeline data comprises identifying a looping sequence in the animation sequence, and
wherein generating markup code comprises generating code that causes the rendering application to iteratively:
render a visual asset;
animate the visual asset; and
remove the visual asset from view.

6. The computing device of claim 1,
wherein analyzing the timeline data comprises analyzing the animation sequence to identify one or more of:
a plurality of sub-sequences based on identifying parallel motion;
a hierarchical object; and
a looping sequence.

7. The computing device of claim 1, wherein:
the data processing hardware comprises a processor; and
the animation coding engine comprises program logic accessible by the processor.

8. The computing device of claim 1, wherein the animation coding engine is included in a development environment configured to use the timeline data to generate a runtime application configured to depict the animation sequence.

9. A computer-implemented method, comprising:
accessing, at a computing device data defining an animation sequence, the animation sequence representing motion of at least one object over time;
accessing, at the computing device data identifying animation primitives supported by a markup language;
analyzing, by the computing device, the data defining the animation sequence to determine a set of visual assets, time-varying properties of respective ones of the set of visual assets, and corresponding animation primitives representing the motion of the at least one object over time; and
generating a package comprising the set of visual assets and a stylesheet defining the corresponding animation primitives as styles to be applied to the visual assets, the package being generated so that, when processed by a rendering application, the rendering application applies the styles to visual assets and invokes the corresponding animation primitives in accordance with the time-varying properties to animate the visual assets to depict the animation sequence.

10. The computer-implemented method of claim 9, wherein the style sheet comprises a cascading style sheet and the rendering application comprises a browser.

11. The computer-implemented method of claim 10, wherein the package further comprises scripting code to be interpreted by the browser when the markup code is processed.

12. The computer-implemented method of claim 9, wherein:
analyzing the data defining the animation sequence comprises decomposing the animation sequence into a plurality of parallel sub-sequences, each sub-sequence representing motion of a different object; and
generating the package comprises generating code that, when processed by the rendering application, causes the rendering application to:
render a plurality of visual assets corresponding to the different objects and
invoke the corresponding animation primitives for the plurality of visual assets in parallel.

13. The computer-implemented method of claim 9, wherein:
analyzing the data defining the animation sequence comprises identifying motion of a hierarchical object; and
generating the package comprises determining a plurality of visual assets associated with the hierarchical object, the corresponding animation primitives for the visual assets defining motion being based on motion of the hierarchical object.

14. The computer-implemented method of claim 9, wherein:
analyzing the data defining the animation sequence comprises identifying a looping sequence in the animation sequence; and
generating the package comprises generating code that causes the rendering application to iteratively:
render a visual asset;
animate the visual asset; and
remove the visual asset from view.

15. The computer-implemented method of claim 9, further comprising:
using the data defining the animation sequence to generate a runtime application configured to depict the animation sequence.

16. A a non-transitory computer-readable medium having stored thereon, program code, that when executed by a computing device, causes the computing device to perform operations, the operations comprising:
providing a design canvas;
receiving input specifying an animation sequence representing a varying appearance of at least one animated object on a stage over time, the animated object comprising a set of visual assets;
storing data defining the animation sequence;
analyzing the data defining the animation sequence to determine the set of visual assets, the data indicating time-varying properties of respective ones of the set of visual assets; and
generating a package comprising the set of visual assets and being configured to invoke animation primitives supported by a rendering application, each visual asset associated with a corresponding animation primitive,
wherein the package is generated so that, when processed by the rendering application, the package causes the rendering application to invoke the corresponding animation primitive for each visual asset in accordance with the time-varying properties to depict the animation sequence.

17. The non-transitory computer-readable medium of claim 16, the operations further comprising:
generating a runtime application based on the data defining the animation sequence, the runtime application being configured to depict the animation sequence when executed.

18. The non-transitory computer-readable medium of claim 16, wherein the package comprises a cascading style sheet specifying the animation primitives as styles to be applied to the visual assets by the rendering application.

19. The non-transitory computer-readable medium of claim 16, wherein analyzing the data defining the animation sequence comprises:
determining a:
visual asset comprised in the animated object;
first position of the visual asset on the stage at a first time index; and
second position of the visual asset on the stage at a second time index; and
wherein generating the package comprises:
generating code for the package that, when processed by the rendering application, causes the rendering application to render the visual asset at a first position in an interface of the rendering application, the first position in the interface corresponding to the first position of the visual asset on the stage at the first time index; and
selecting an animation primitive that, when processed by the rendering application, causes the rendering application to move the visual asset to a second position in the interface, the second position in the interface corresponding to the second position of the visual asset on the stage at the second time index.

20. The non-transitory computer-readable medium of claim 16, wherein analyzing the data defining the animation comprises decomposing the animation sequence into a plurality of sub-sequences based on identifying one or more of:
parallel motion of a plurality of animated objects;
motion of a hierarchical object; and
a looping sequence.
